(19) United States
(12) Patent Application Publication
(10) Pub. No.: US 2005/0258274 A1
(43) Pub. Date: Nov. 24, 2005

(54) WATER SPRAYER

(75) Inventor: Kuan-Hsiung Wang, Changhua (TW)

Correspondence Address: BACON & THOMAS, PLLC, 625 SLATERS LANE, FOURTH FLOOR, ALEXANDRIA, VA, 22314, US

(73) Assignee: Hsin Yuirs Industrial Co., Ltd., Changhua (TW)

(21) Appl. No.: 10/896,923

(22) Filed: Jul. 23, 2004

(30) Foreign Application Priority Data
May 4, 2004 (TW) 93206924

(51) Int. Cl. A62C 31/02

(52) U.S. Cl. 239/393; 239/392; 239/444; 239/448; 239/449; 239/525; 239/526; 239/436

(57) ABSTRACT

A water sprayer includes a housing and a water wheel holder connected to the housing. The water wheel holder has a receiving chamber therein in communication with a water inlet in the housing, a first water outlet, and a second water outlet formed of a plurality of fine holes. A water wheel is rotatably stepwise mounted in the water wheel holder and located inside the receiving chamber. The water wheel has a plurality of primary water passages, which are selectively connectable between the water inlet and the first water outlet for guiding water from the water inlet to the first water outlet, and a secondary water passage, which is selectively connectable between the water inlet and the second water outlet for guiding water from the water inlet to the second water outlet.

### BACKGROUND OF THE INVENTION

1. Field of the Invention

The present invention relates watering apparatus for gardening and more particularly, to a water sprayer that can easily be controlled to change the spray pattern of water.

2. Description of the Related Art

FIG. 1 shows a water sprayer according to the prior art. According to this design, the water sprayer 1 (the so-called pistol nozzle) comprises a housing 2, a control lever 3, and a spray-pattern dial assembly 4. The housing 2 comprises a handle 2a, which defines therein a water passage (not shown) connectable to water source, and a dial mount 2b. The dial mount 2b comprises a water outlet 2d in communication with the water passage in the handle 2a, and a screw hole 2c. The control lever 3 is pivoted to the housing 2 and adapted to control supply of water to the water passage in the dial mount 2b. The spray-pattern dial assembly 4 is comprised of a base 4a and a dial 4b. The base 4a is affixed to the dial mount 2b, having a water guide hole 4c in communication with the water outlet 2d. The dial 4b is rotatably coupled to the base 4a. A screw 5 is inserted through the dial 4b and the base 4a and threaded into the screw hole 2c to secure the dial 4b to the base 4a and the dial mount 2b, allowing rotation of the dial 4b on the screw 5 relative to the base 4a. The dial 4b has a plurality of water nozzle holes 4d and a stopper 4e equiangularly spaced in the front side thereof around the screw 5, and a plurality of micro nozzle holes 4f formed in the front side around the border area.

When in use, the user rotates the dial 4b to select one water nozzle hole 4d into alignment with the water guide hole 4c, and then presses the control lever 3 to let water to pass out of the selected water nozzle hole 4d. When shifted the stopper 4e to the water guide hole 4c, water is forced to change the path and to pass out of the dial 4b through the micro nozzle holes 4f.

The aforesaid prior art water sprayer is functional, however it has drawbacks as follows:

1. If the user uses the water sprayer to spray a chemical solution, the user's hand may be contacted by the sprayed chemical solution when changing the spray pattern during operation.

2. When changing the spray pattern, the user must hold the handle 2a of the water sprayer 1 with one hand, and then rotating the dial 4b with the user hand. This pattern changing procedure is not easy to perform.

3. Upon an impact (for example, falling of the water sprayer 1 to the ground accidentally), the connection between the screw hole 2c and the screw 5 may break. The water sprayer may become not usable when the connection between the screw hole 2c and the screw 5 is damaged.

Therefore, it is desirable to provide a water sprayer that eliminates the aforesaid drawbacks.

### SUMMARY OF THE INVENTION

It is the primary objective of the present invention to provide a water sprayer, which enables the user to change the spray pattern conveniently.

It is another objective of the present invention to provide a water sprayer, which can easily be operated with one single hand to change the spray pattern thereof.

It is still another objective of the present invention to provide a water sprayer, which has a strong structure, and is durable in use.

It is still another objective of the present invention to provide a water sprayer, which prevents contact of the user's hand with the sprayed fluid when changing the spray pattern.

To achieve these objectives of the present invention, the water sprayer comprises a housing having a water inlet, and a water wheel holder, which is connected to the housing and defines a receiving chamber therein in communication with the water inlet of the housing. The water wheel holder further comprises a first water passage, a second water passage, a first water outlet and a second water outlet that is formed of a plurality of fine holes. A water wheel is rotatably stepwise mounted in the water wheel holder and located inside the receiving chamber. The water wheel has a plurality of primary water passages, which are selectively connectable between the water inlet and the first water outlet through the first water passage for guiding water from the water inlet to the first water outlet, and a secondary water passage, which is selectively connectable between the water inlet and the second water outlet through the first water passage and the second water passage for guiding water from the water inlet to the second water outlet. A control unit is provided for stepwise rotating the water wheel relative to the water wheel holder, thereby selectively connecting one of the primary and secondary water passages to one of the first and second water outlets.

### BRIEF DESCRIPTION OF THE DRAWINGS

FIG. 1 is an exploded view of a water sprayer according to the prior art.

FIG. 2 is a partial sectional view of a water sprayer according to a preferred embodiment of the present invention, showing water sprayed out of the first water outlet.

FIG. 3 is a front view of the water wheel holder and the water wheel in the water wheel holder according to the preferred embodiment of the present invention.

FIG. 4 is a sectional view of a part of the preferred embodiment of the present invention, showing the positioning of the water wheel in the receiving chamber of the water wheel holder according to the present invention.

FIG. 5 is a partial sectional view of the preferred embodiment of the present invention, showing the positions of the water passages and water outlets of the water wheel holder.

FIG. 6 is a sectional view taken along line 6-6 of FIG. 5.

FIG. 7 is a sectional view taken along line 7-7 of FIG. 5.

FIG. 8 is a perspective view of the water wheel for the water sprayer according to the preferred embodiment of the present invention.

FIG. 9 is a left side view of the water wheel for the water sprayer according to the preferred embodiment of the present invention.

FIG. 10 is a right side view of the water wheel for the water sprayer according to the preferred embodiment of the present invention.

FIG. 11 is a development drawing showing a circumferential peripheral wall of the water wheel for the water sprayer according to the preferred embodiment of the present invention.

FIG. 12 is similar to FIG. 2 but showing the control lever pressed.

FIG. 13 is similar to FIG. 2 but showing water sprayed out of the second water outlet.

FIG. 14 corresponds to FIG. 13, showing the relative positioning between a secondary water passage of the water wheel and the second water passage of the water wheel holder.

FIG. 15 is a front view of the water wheel holder corresponding to the position shown in FIG. 13.

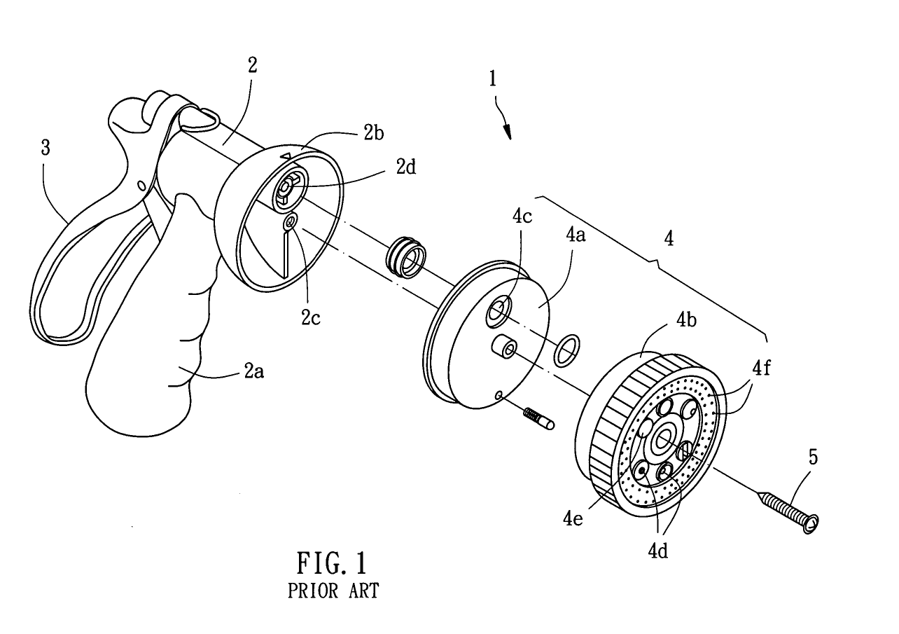

### DETAILED DESCRIPTION OF THE INVENTION

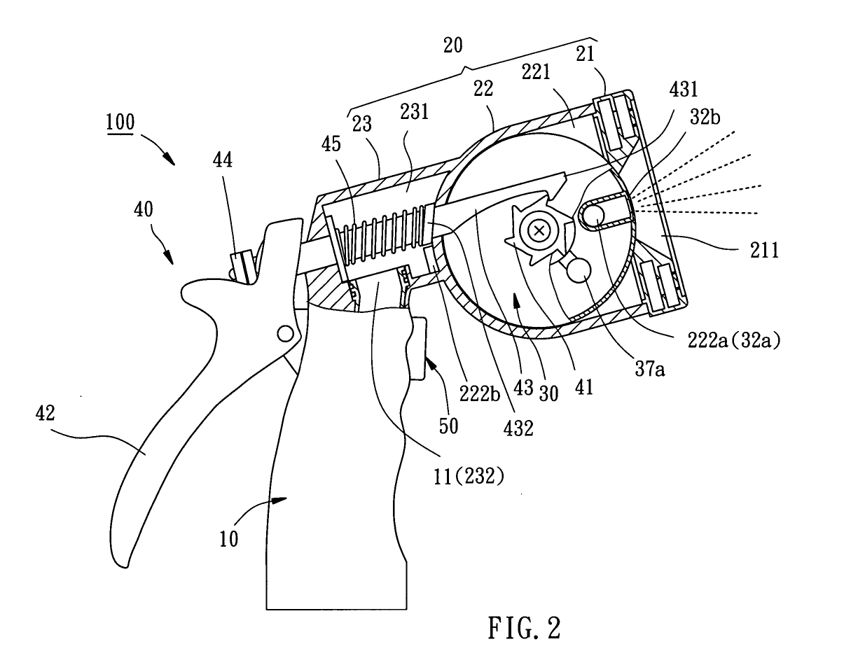

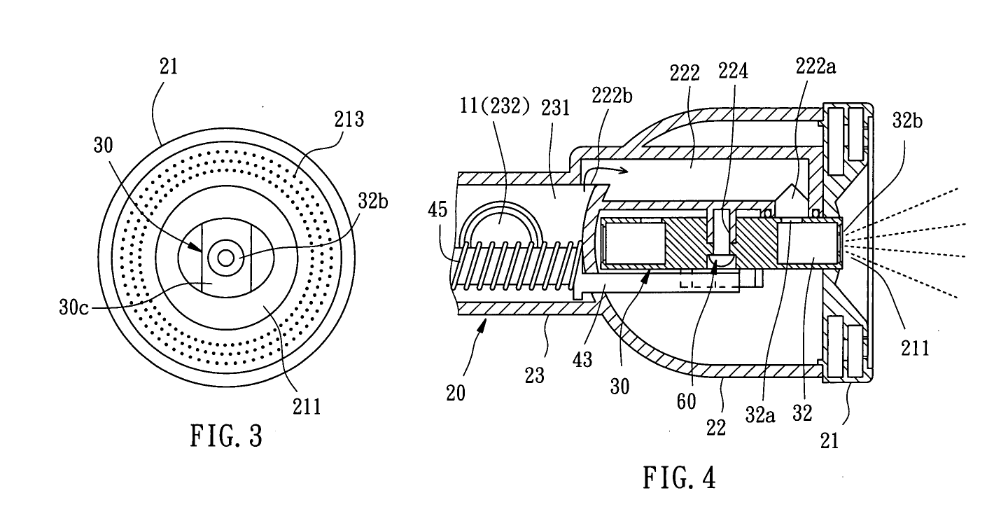

Referring to FIGS. 2-4, a water sprayer 100 in accordance with the preferred embodiment of the present invention is shown comprised of a housing 10, a water wheel holder 20, a water wheel 30, a control unit 40, and a switch 50.

The housing 10 is made for the holding of the hand, comprising a water inlet 11 connectable to an external water source.

The water wheel holder 20 comprises a head 21 at the front side, a rear extension 23 at the rear side, and a body 22 connected between the head 21 and the rear extension 23. The body 22 defines therein a receiving chamber 221. The rear extension 23 has a water chamber 231, and a mounting through hole 232 extended across the water chamber 231. By means of the mounting through hole 232, the water wheel holder 20 is fastened to the housing 10, keeping the water chamber 231 in fluid communication with the water inlet 11.

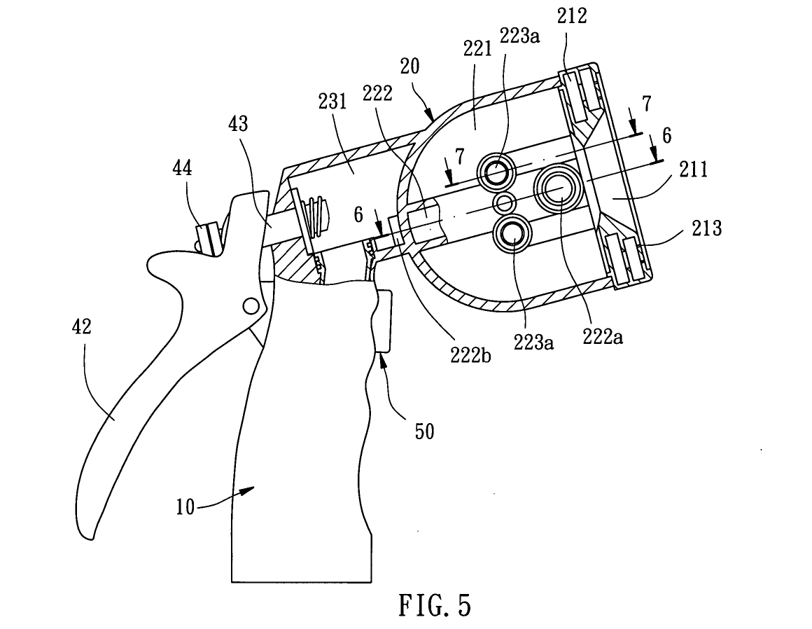

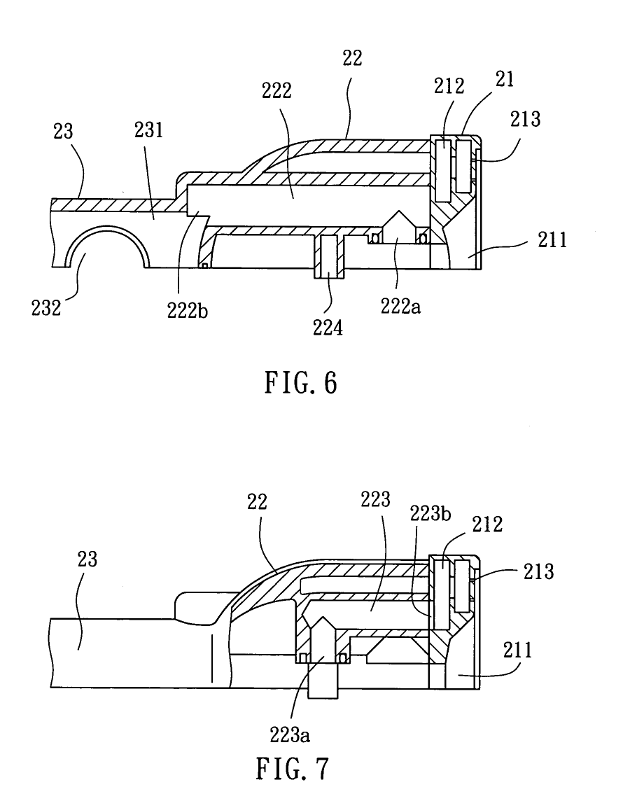

Referring to FIGS. 5-7 and FIGS. 2-4 again, the head 21 comprises a first water outlet 211 in communication with the receiving chamber 221 around the water wheel 20, an annular water passage 212 formed inside the head 21 around the first water outlet 211, a second water outlet 213, which is formed of a plurality of fine holes, in communication between the annular water passage 212 and the outside of the water wheel holder 20.

The body 22 comprises a first water passage 222, two second water passages 223, and a locating hole 224. The first water passage 222 has a front end 222a in communication with the receiving chamber 221 of the head 21, and a rear end 222b in communication with the water chamber 231 of the rear extension 23. The two second water passages 223 each have a front end 223a in communication with the receiving chamber 221 of the head 21, and a rear end 223b in communication with the annular water passage 212 of the head 21.

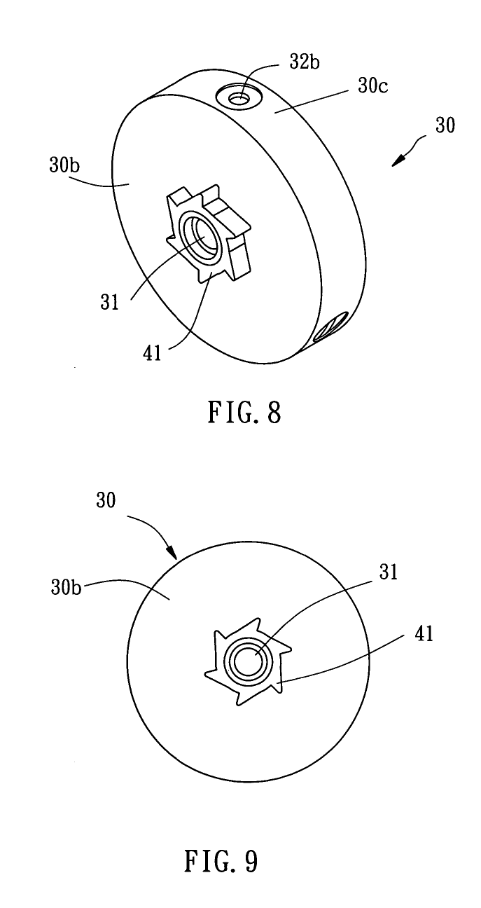

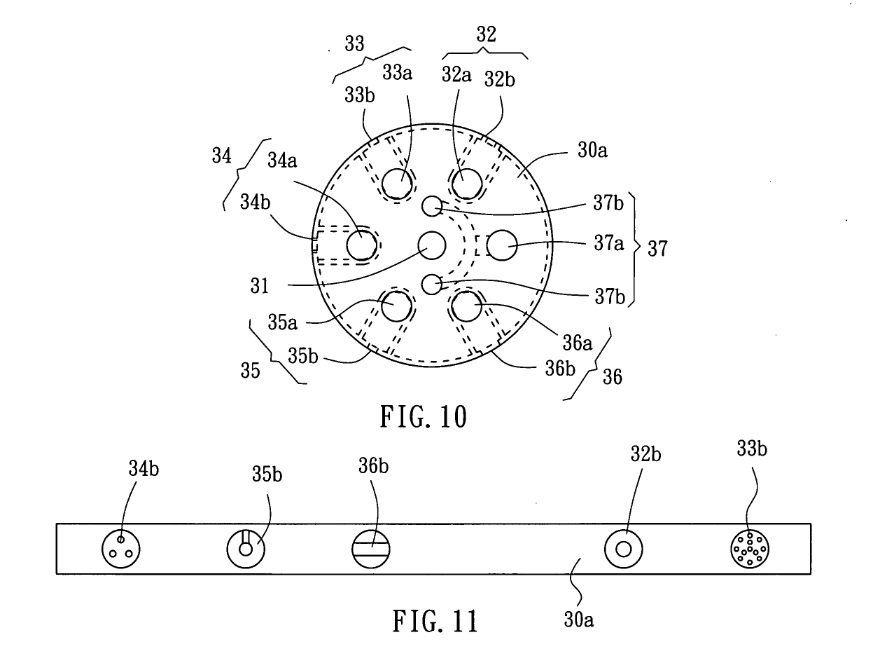

Referring to FIGS. 8-11, the water wheel 30 has two opposite sidewalls 30a, 30b, a circumferential peripheral wall 30c, and an axle hole 31 extended through the sidewalls 30a, 30b at the center. A pivot pin 60 is inserted through the axle hole 31 and fastened to the locating hole 224 (see FIG. 4) to secure the water wheel 30 to the water wheel holder 20 inside the receiving chamber 221, allowing the water wheel 30 to be rotated on the pivot pin 60. The water wheel 30 has a plurality of primary water passages 32-36 and a secondary water passage 37. The primary water passages 32-36 each have a water input end 32a-36a formed in one sidewall 30a of the water wheel 30, and a water output end 32b-36b spaced around the peripheral wall 30c. The water output ends 32b-36b of the primary water passages 32-36 have different cross-sections as shown in FIG. 11. The secondary water passage 37 has a water input end 37a and two water output ends 37b respectively formed in one sidewall 30a of the water wheel 30.

The control unit 40 comprises a ratchet wheel 41, a control lever 42, a driving member 43, a stop block 44, and a return member formed of a spring 45. The ratchet wheel 41 is mounted on the other sidewall 30b of the water wheel 30 in a coaxial manner relative to the axle hole 31. According to this embodiment, the number of the teeth of the ratchet wheel 41 is equal to the total number of the water passages of the water wheel (i.e., 6).

The lever 42 is pivoted to an upper part of the housing 10 for operation by the user.

The driving member 43 is a rod member inserted through the chambers 221, 231 of the water wheel holder 20, having a pawl 431 extended from the first end thereof and adapted to engage the ratchet wheel 41 and a flange 432 extended around the periphery. The second end of the driving member 43 is extended out of the water wheel holder 20 and inserted through the top end of the control lever 42 and fixedly connected to the stop block 44.

The spring 45 is sleeved onto the driving member 43 and located in the water chamber 231, having one end stopped at the flange 432 and the other end stopped at an inside wall of the water wheel holder 20.

The switch 50 is mounted in the front side of the housing 10 for pressing by the user's finger to control the flowing of water through the water inlet 11 into the inside of the water wheel holder 20. Because the control structure of the switch 50 is of the known art not within the scope of the claims of the present invention, no further detailed description in this regard is necessary.

The operation of the water sprayer is outlined hereinafter. Referring to FIGS. 2-4 again, when the user pressed the switch 50 with the finger (forefinger), intake water is allowed to pass through the water chamber 231 into the inside of the water wheel 30 via the first water passage 222, and then to pass from the front end 222a of the first water passage 222 into, for example, the water input end 32a of the primary water passage 32 and then to pass to the outside of the first water outlet 211 of the water wheel holder 20 via the water output end 32b of the primary water passage 32.

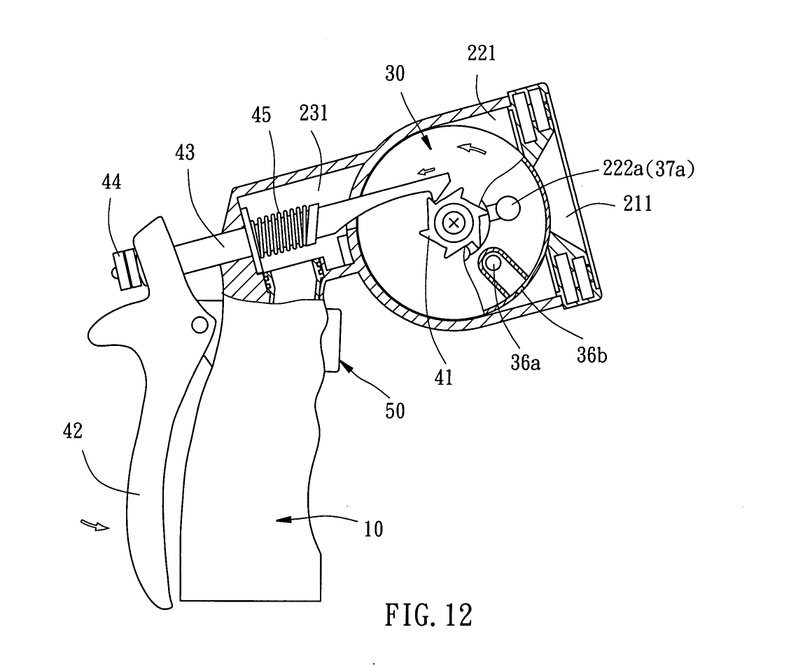

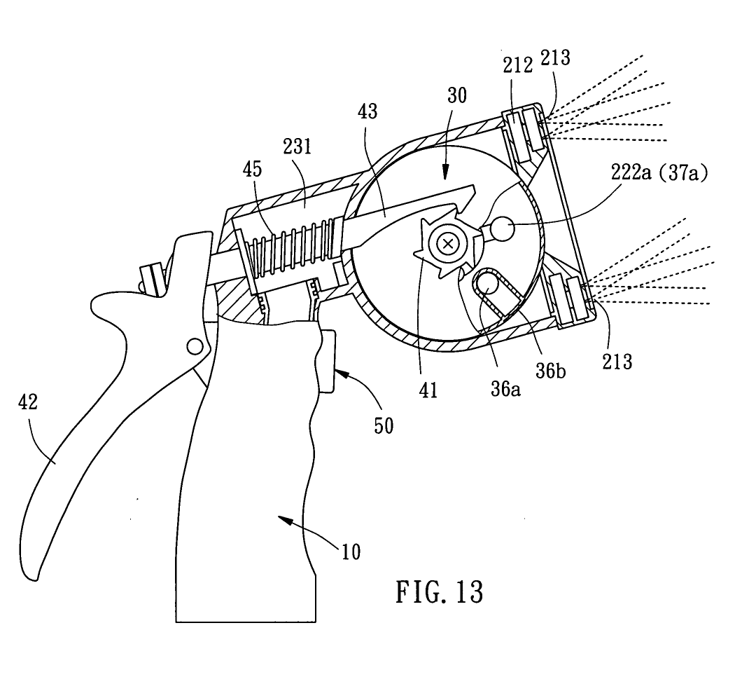

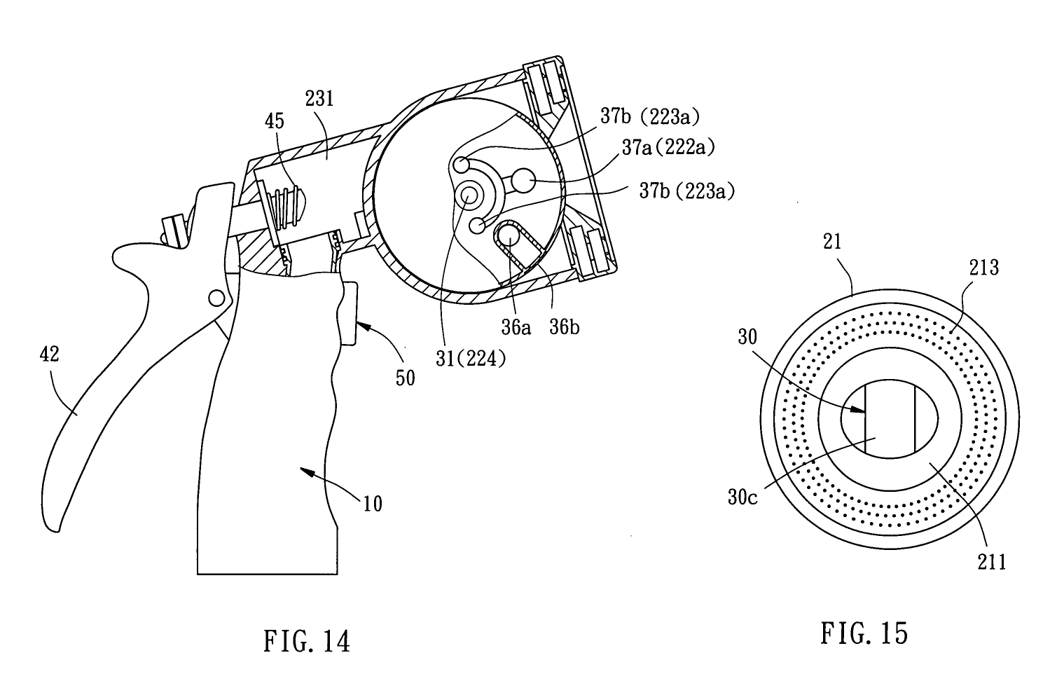

Referring to FIGS. 12-15, when rotating the water wheel 30 to aim the water input end 37a of the secondary water passage 37 at the front end 222a of the first water passage 222, intake water is forced to pass through the water output ends 37b of the water passage 37 into the two second water passages 223 of the water wheel holder 20, and then to pass out of the water wheel holder 20 through the second water outlet 213 via the annular water passage 212.

As indicated above, when the user wishing to change the spray pattern, the user needs only to press the control lever 42 with one finger (the thumb) to drive the driving member 43 to stepwise rotate the ratchet wheel 41 and the water wheel 30. When released the finger from the control lever 42, the spring 45 immediately returns the driving member 43 to the former position. Therefore, when rotating the water heel 30 step by step, the water passages 32-37 are selectively shifted into communication with the first water passage 222 and the first water outlet 211 or the second water outlets 213 one after another, thereby changing the desired water spray pattern.

As indicated above, the invention has the following advantages:

1. When using the water sprayer 100, the user holds the water sprayer with one single hand and can close and open the water sprayer and control the water spray pattern with one finger of the same hand.

2. When changing the water spray pattern, the user's hand does not touch sprayed water, preventing contact of toxic chemical substance contained in sprayed water.

3. The structure of the water sprayer 100 is stable and durable, not easy to break.

1. A water sprayer comprising:
a housing having a water inlet;
a water wheel holder connected with said housing, said water wheel holder having a receiving chamber, a first water passage, at least one second water passage, an annular water passage, a first water outlet, and a second water outlet, said first water passage being communicated between said water inlet and said receiving chamber, said second water passage being communicated between said receiving chamber and said annular water passage, said first water outlet being communicated with said receiving chamber for guiding water to the outside of said water wheel holder, said second water outlet being communicated with said annular water passage for guiding water to the outside of said water wheel holder;
a water wheel rotatably mounted in said water wheel holder and located inside said receiving chamber, said water wheel having a plurality of primary water passages, which are selectively connectable between said first water passage and the first outlet, and a secondary water passage, which is selectively connectable between the first water passage and said second water passage;
a control unit having a ratchet wheel coaxially mounted on one side of said water wheel, and a driving member controlled by an external force to synchronously stepwise rotate said ratchet wheel and said water wheel; and
a switch for controlling the flow of water from said water inlet to said first water passage.

2. The water sprayer as claimed in claim 1, wherein said control unit further comprises a return member for returning said driving member after each operation of said driving member.

3. The water sprayer as claimed in claim 2, wherein said control unit further comprises a lever pivoted to said housing for driving said driving member to rotate said ratchet wheel and said water wheel.

4. The water sprayer as claimed in claim 3, wherein said return member is a spring; said driving member is a rod member inserted through said water wheel holder and said spring, said rod member having a first end, a pawl provided at said first end thereof and engaged with said ratchet wheel, a second end extended out of said water wheel holder, a stop block fixedly provided at said second end and stopped against one end of said lever.

5. The water sprayer as claimed in claim 1, wherein said water wheel holder comprises a body and a head at one end of said body, said body defining said receiving chamber and said first water passage and said second water passage therein; wherein said first water outlet is disposed at a center of said head; said annular water passage is formed in said head around said first water outlet; said second water outlet comprises a plurality of fine holes for guiding water from said annular water passage to the outside of said water wheel holder.

6. The water sprayer as claimed in claim 5, wherein said water wheel holder further comprises a rear extension extended from a rear side of said body opposite to said head, said rear extension defining a water chamber in communication between said water inlet and said receiving chamber, said rear extension having a mounting through hole for the mounting of said housing; wherein said switch is mounted to said housing.

7. The water sprayer as claimed in claim 1, wherein a number of teeth of said ratchet wheel is equal to a total number of said primary water passages and said secondary water passage of said water wheel.

8. The water sprayer as claimed in claim 1, wherein said primary water passages of said water wheel each have a first end formed in one side of said water wheel and a second end formed in a circumferential periphery of said water wheel, the second ends of said primary water passages having different cross-sections.
